(19) United States
(12) Patent Application Publication
(10) Pub. No.: US 2025/0081991 A1
(43) Pub. Date: Mar. 13, 2025

(54) SOFT CHEW BASED ON RICE STARCH

(71) Applicant: VIRBAC, Carros (FR)

(72) Inventors: Patricia Monginoux, Villeneuve Loubet (FR); Nathalie Jouty, La Roquette sur Var (FR); Anne Endrizzi, Auxonne (FR); Jean-Marie Delaitre, QUETIGNY (FR)

(73) Assignee: VIRBAC, Carros (FR)

(21) Appl. No.: 18/722,152

(22) PCT Filed: Dec. 22, 2022
(86) PCT No.: PCT/EP2022/087503

§ 371 Date: Jul. 5, 2024

(30) Foreign Application Priority Data
Dec. 23, 2021 (EP) 21217293.6

(51) Int. Cl. A23K 40/25; A23K 10/30; A23K 20/158; A23K 20/163

(52) U.S. Cl. CPC A23K 40/25; A23K 10/30; A23K 20/158; A23K 20/163

(57) ABSTRACT

Soft chew formulations have at least one nutraceutical ingredient and/or at least one pharmaceutical active substance; no more than 6 wt. % oil, fat or a mixture thereof based on the total weight of the soft chew; and starch. At least 50 wt. % by weight of total starch present in the soft chew is provided by pregelatinized rice flour, and the soft chew contains substantially no palatable agent of animal origin.

### FIELD OF THE INVENTION

The present invention relates to a soft chew comprising at least one nutraceutical ingredient and/or a pharmaceutical active substance for the administration to animals, a process for manufacturing said soft chew and the use of such soft chew.

### BACKGROUND TO THE INVENTION

The acceptance of a pharmaceutical or a nutraceutical (or complementary feed) by a pet is determined mainly by its odour and taste. The palatability of a chewable medicinal product is also largely determined by its texture and the mouthfeel generated. In the case of dogs, soft structures are preferred considerably to hard and brittle structures such as tablets.

In recent years, there have been tremendous efforts to manufacture soft chewable dosage forms based on flavoured starch extrudates because many constraints in the formulation of a soft chew exist.

For example, due to regulations by the European Commission on the import of substances of animal origin, regulations that are also found in many countries of Asia and Latin America, it is highly preferable to use as few as possible ingredients of animal origin, ideally none. Substances of animal origin are however rich in proteins—providing consistency to the soft chew—and fats—making the dough more easily processable. Substances of animal origin are also appealing to carnivores such as dogs and cats and make the soft chew more palatable. In addition, many nutraceuticals and pharmaceutical active ingredients are heat sensitive and it is necessary to manufacture the soft chews at ambient temperature to prevent their degradation. The dough to be formed into a soft chew must therefore have a viscosity that is compatible with the machines used for the manufacture of the soft chew (mixers, molding machines, extruders), which as explained above, is rendered more difficult when not using substances of animal origin.

WO2013025183 discloses multi-textured animal treats. The multi-textured animal treat includes one or more soft component comprising a mechanical joint that is wrapped around a hard component fixedly attached to the mechanical joint on the soft component. The soft component has a hardness between about 4 and 89 N and is free of pregelatinized rice flour. The hard component has a hardness between about 110 and 260 N. In example 4, it is showed that pregelatinized starch provides a higher hardness (about 250 N) than pregelatinized corn flour (215 N) to the hard component.

WO2017025883 discloses edible animal hard chews, intended as dental treats (i.e. to clean the teeth of an animal). These edible chews require at least one minute of chewing before the product can be ingested, for example one to four minutes of chewing before the product can be ingested. In example 2 (table 3), the hardness of such dental treats was determined to be of about 300 N.

US20040086616 patent application discloses starch-based extruded products which are suitable as long-lasting dog chews. The starch-based extruded products are described as being tough (hard) yet pliable and can be chewed for about 10 to 25 minutes.

US2006193959 discloses low calorie starch-based chew products. These chew products are tough for an animal to chew, non-brittle, non-slimy and readily hydratable for quick disintegration, as well as characterized by a total dietary fiber content of at least 5%.

An object of the invention is a soft chew meeting the following criteria:
a) it has a palatable taste to the animal,
b) it is nutritionally acceptable to the target animal,
c) it is stable over time and does not oxidize (to prevent degradation of the active ingredients),
d) it contains substantially no animal ingredients or as few as possible,
e) it has a texture, and in particular a firmness, acceptable to the animal.

To meet criteria a) to d), the soft chew must ideally be without palatable agents of animal origin and the lipids should be as low as possible, in particular less than 10%. Indeed, too much lipids would make the soft chew nutritionally less acceptable and the oxidation of lipids can have a significant negative effect on soft chew quality, impacting color, nutrition, palatability, odour, taste, the stability of the active ingredients, and shelf life, the most recognizable sign of lipid oxidation being altered odour and flavour.

Low amounts of lipids of less than 10%, however, make the dough difficult to process (due to high viscosity of the dough) and result in soft chews having a texture that is not acceptable to the animal (criteria e)). Starting from the teaching of prior art, several attempts to obtain a dough that was processable (e.g. not too viscous) resulted in soft chews having a texture, and in particular a firmness, not acceptable to the animal. Furthermore, the low proportion of lipids in a formulation containing mostly hydrophilic ingredients, combined with a cold process, resulted in exudation of the oil contained in the soft chews.

The technical problem underlying the present invention is therefore to provide a soft chew that is low in lipids, is palatable and has a texture that is acceptable to the animal. It is also an object of the invention to provide a process that makes it possible to process a dough into such a soft chew, preferably without additional heat.

### SUMMARY OF THE INVENTION

In a first aspect the invention relates to an improved soft chew formulation comprising:
at least one nutraceutical ingredient and/or at least one pharmaceutical active substance;
no more than 6 wt. % oil, fat or a mixture thereof based on the total weight of the soft chew; and
starch;
wherein at least 50 wt. % by weight of total starch present in the soft chew is provided by pregelatinized rice flour.

When pregelatinized rice flour was used in sufficient proportion with respect to the total starch present in the soft chew, the resulting dough had an acceptable viscosity for extrusion, the soft chew had an acceptable texture, in particular firmness, and oil did not exude from the soft chew. Conversely, when native (ungelatinized) starch was used, including native (ungelatinized) rice starch, or pregelatinized starches conventionally used in the manufacture of soft chews such as potato, corn or wheat starch, the viscosity of the dough was high and the manufacture of soft chews having satisfactory properties, in particular in terms of texture and/or oil exudation was difficult.

In another aspect, the invention relates to a process for manufacturing a soft chew, comprising the following steps:
i. mixing the following components:
   at least one nutraceutical ingredient and/or at least one pharmaceutical active substance,
   at least one source of starch,
   pregelatinized rice flour in an amount sufficient to provide at least 50 wt. % by weight of the total starch weight,
   no more than 6 wt. % oil, fat or a mixture thereof based on the total weight of the components,
ii. forming a soft chew.

In another aspect, the invention relates to a soft chew, said soft chew comprising at least one pharmaceutical active substance, at least one source of starch, no more than 6 wt. % oil, fat or a mixture thereof based on the total weight of the components and wherein at least 50 wt. % by weight of total starch present in the soft chew is provided by pregelatinized rice flour, for use as a medicament for animals.

In another aspect, the invention relates to the use of a soft chew, said soft chew comprising at least one nutraceutical ingredient, at least one source of starch, no more than 6 wt. % oil, fat or a mixture thereof based on the total weight of the components and wherein at least 50 wt. % by weight of total starch present in the soft chew is provided by pregelatinized rice flour, for providing a pet with a health benefit.

### DESCRIPTION OF THE FIGURES

FIG. 1 is a graphical representation of the firmness measured for 2 g and 6 g soft chews. The X-axis identifies the soft chew (A, B, C or D, A2g identifying the soft chew of formula A weighing 2g) and the Y-axis provides the firmness in kgf.

### DETAILED DESCRIPTION OF THE INVENTION

Unless otherwise stated, all percentages are expressed as weight percent.

As used herein, when a soft chew contains “substantially no ingredient”, it is to be understood that the soft chew contains less than 5%, preferably less than 1% and more preferably 0% of said ingredient.

As used herein, when a range of values is expressed as “comprised between x and y”, this range includes the end-points x and y.

In a first aspect the invention relates to a soft chew comprising:
at least one nutraceutical ingredient and/or at least one pharmaceutical active substance;
no more than 6 wt. % oil, fat or a mixture thereof based on the total weight of the soft chew; and
starch;
wherein at least 50 wt. % by weight of total starch weight present in the soft chew is provided by pregelatinized rice flour.

The present invention more particularly relates to a soft chew comprising:
at least one nutraceutical ingredient and/or at least one pharmaceutical active substance;
no more than 6 wt. % oil, fat or a mixture thereof based on the total weight of the soft chew;
at least one palatant, and
starch,
wherein at least 50 wt. % by weight of total starch weight present in the soft chew is provided by pregelatinized rice flour,
wherein the soft chew contains substantially no palatant of animal origin, and
wherein the soft chew has a firmness comprised between 25 and 100 N.

The soft chew according to the present invention is preferably intended for immediate consumption. By “immediate consumption”, it is meant that the soft chew is consumed by the animal in less than 1 minutes, i.e. between 1 second and 60 seconds.

More preferably, the soft chews according to the present invention contain substantially no palatant of animal origin and substantially no excipient, i.e. inert ingredients, of animal origin. In such an embodiment, the sole ingredients of animal origin are the at least one nutraceutical ingredient and/or at least one pharmaceutical active substance.

More preferably, the soft chews according to the present invention contain an oil and no fat or mixture of oil and fat.

In the sense of the present invention, a soft chew is a formed body exhibiting a meat-like or stock cube soft texture that can be chewed readily by animals such as dogs and cats while providing a pleasant mouthfeel to the animals. The term soft texture as used herein refers to a texture, which holds its shape until certain levels of pressure are applied. In the sense of the present invention, a soft chew is a discrete dosage form, in particular a veterinary discrete dosage form, intended to deliver to the animal a pharmaceutical or nutraceutical substance.

The size and shape of the soft chew may be adapted to the type of animal (dog or cat) and to the size of the animal. The weight of the soft chew typically ranges from 0.1 g to 20 g, preferably from 0.5 g to 10 g and most preferably from 1 g to 6 g. In particular embodiments, the soft chews weight 0.5, 1, 2, 4 or 6 g.

There exist several parameters that can be used to define the texture of a soft chew, such as firmness, softness, hardness, toughness, springiness, break force, ripeness, skin strength, work of penetration, work of extrusion. The texture of the soft chew can be determined using methods and apparatuses well known in the art, in particular texture analyzers.

Hardness, firmness and softness all represent the force required to deform the product to a given distance. However, depending upon the product type, one word may be more favorable to use than the other. Softness and firmness is preferably employed to define products that display a slight or moderate resistance to deformation (a low or moderate force is required to deform the product to the given distance). In contrast, hardness is preferably employed to define products that display high resistance to deformation (a high force is required to deform the product to the given distance).

In the present invention, a soft chew is defined as a formed body having a plastic behavior, i.e. it is not brittle and has a firmness comprised between 25 and 100 N. Preferably, the firmness is comprised between 39 and 79 N, more preferably between 40 and 60 N.

The firmness of the soft chews was determined on a TA XT Plus texturometer (Stable Micro Systems) using a P/0,5S spherical probe of 0.5 inches (1.27 cm) with the following parameters implemented directly in the software of the texturometer:

| Caption | Value | Units |
|---|---|---|
| Test Mode | Compression | |
| Pre-Test Speed | 1.00 | mm/sec |
| Test Speed | 2.00 | mm/sec |
| Post Test Speed | 5.00 | mm/sec |
| Target Mode | Distance | |
| Distance | 3.00 | mm |
| Trigger Type | Auto (Force) | |
| Trigger Force | 5.0 | g |
| Break Mode | Off | |
| Stop Plot at | Start Position | |
| Tare Mode | Auto | |

Briefly, the sample (soft chew) was placed on a flat base/surface and the spherical probe was lowered into the sample to a distance of 3 mm at a predetermined speed. The sample was deformed by the probe and the resistance offered by the sample (force required to penetrate of 3 mm) was recorded. The measured resistance expressed in kgf (1 kgf=9,80665 N) corresponds to the firmness of the soft chews.

Firmness (Hardness/Softness) of the product may also be represented by the maximum force (load) reached prior to fracture of the product, or break force. The soft chews of the present invention are characterized by a break force of less than 100 N, in particular comprised between 20 and 100 N, more particularly between 20 and 90 N.

The break force was determined on a TA XT Plus texturometer (Stable Micro Systems) using a spherical probe of 10 mm of diameter or a conical probe of 10 mm diameter (mimicking the shape of a dog or cat tooth), with the following parameters implemented directly in the software of the texturometer:

| Caption | Value | Units |
|---|---|---|
| Test Mode | Compression | |
| Pre-Test Speed | 1.00 | mm/sec |
| Test Speed | 1.00 | mm/sec |
| Post Test Speed | 10.00 | mm/sec |
| Target Mode | Distance | |
| Force | 100 | g |
| Distance | 10.00 | mm |
| Trigger Type | Auto (Force) | |
| Trigger Force | 0.5 | g |
| Break Mode | Off | |

Briefly, the sample (soft chew of 4 g, about 12 mm thickness) was placed on a flat base/surface and the spherical or conical probe was lowered into the sample to a distance of 10 mm at a predetermined speed. The sample was deformed by the probe until breakage. The resistance offered by the sample (maximum force applied to break the sample) or break force was recorded. The measured resistance expressed in kgf (1 kgf=9,80665 N) corresponds to the break force of the soft chews. The break force measured under these conditions with the conical probe was about 63 N while it was about 84 N with the spherical probe.

The soft chew according to the present invention are starch based soft chews. The soft chews typically contain between 15 and 50 wt. % of starch based on the total weight of the soft chew. Preferably, the soft chews contain between 15 and 25 wt. % of starch.

While the soft chews may contain any starch, the starch is preferably selected from the group consisting of potato starch, wheat starch, barley starch, oat starch, rice starch, tapioca starch, maize (corn) starch, pea starch and cassava starch. The starch may be ungelatinized, partially gelatinized or fully gelatinized. Preferably, the starch is partially gelatinized or fully gelatinized.

In order to obtain soft chews having the desired texture and properties according to the present invention, at least 50 wt. % of the total weight of starch should be provided by pregelatinized rice flour. Preferably, at least 60 wt. % of the total weight of starch should be provided by pregelatinized rice flour, even more preferably at least 70 wt. %. In particular, between 60 and 100 wt. %, more particularly between 70 and 90 wt. % of the total weight of starch should be provided by pregelatinized rice flour.

The pregelatinized rice flour is preferably selected from Japonica rice flour, Indica rice flour and Javanica rice flour. More preferably, the pregelatinized rice flour is Indica rice flour.

The oil is preferably an oil of non-animal origin. Said oil of non-animal origin is in particular a vegetable oil selected from the group consisting of coconut oil, corn oil, canola oil, cottonseed oil, olive oil, palm oil, peanut oil, rapeseed oil, safflower oil, sesame oil, soybean oil and sunflower oil, or mixtures thereof. Preferably, the oil is sunflower.

The fat can be a solid fat of animal origin (for example butter, lard, or beef tallow) or a solid fat of non-animal origin (for example cocoa butter, peanut butter, solid hydrogenated vegetable oils). Preferably, the fat is of non-animal origin.

The amount of oil, preferably of vegetable oil, fat or a mixture thereof is comprised between 3 and 6 wt. % based on the total weight of the soft chew, more preferably about 5%. An amount of up to 6% of oil, fat or a mixture thereof makes it possible to maintain the level of lipids in the soft chew below 10%.

Preferably, the soft chew according to the invention contains an amount of oil, preferably of vegetable oil, comprised between 3 and 6 wt. % based on the total weight of the soft chew, more preferably about 5%.

The present invention therefore further concerns a soft chew as described herein comprising no more than 10 wt. % of lipids.

In the sense of the present invention, an amount of “no more than 6 wt. % oil, fat or a mixture thereof” refers to the amount of oil, fat, or a mixture thereof that is present in the dough employed for manufacturing the soft chew and the soft chew.

An amount of “no more than 10 wt. % lipids” refers to the amount of lipids, including oil and fat and other lipids brought by the other ingredients of the improved soft chew formulation according to the invention, as measured in the soft chew by analytical methods. Such analytical methods are known in the art and include, for example, solvent extraction-gravimetric method or gas chromatography.

The soft chews of the present invention comprise at least one nutraceutical ingredient and/or at least one pharmaceutical active substance. The active ingredient is preferably a veterinary active ingredient or veterinary nutraceutical ingredient.

The pharmaceutical active substance can be selected from the group consisting of anesthetics, corticosteroids, NSAIDs, antibiotics, antiemetics, parasiticidal agents and JAK-1 inhibitors.

The NSAID can be selected among meloxicam, grapiprant, carprofen, naproxen, tolfenamic and meclofenamic acids, flunixin and indomethacin.

The anthelmintic can be selected among macrocyclic lactones, such as abamectin, moxidectin, avermectins, ivermectin, selamectin or cydectin, milbemycin; benzimidazoles such as mebendazole, fenbendazole, oxfendazole, albendazole, thiabendazole or carbendazol; imidazothiazoles such as levamisole or pyrantel pamoate; salicylanilides such as closantel or niclosamide.

The antibiotic can be selected among penicillins, aminopenicillins (e.g., amoxicillin, ampicillin, hetacillin), cephalosporins (e.g., cefovecin, cefuroxime, ceftiofur), quinolones (e.g., ciprofloxacin, enrofloxacin, difloxacin, orbifloxacin, marbofloxacin); chloramphenicols (e.g., chloramphenicol, thiamphenicol, florfenicol); tetracyclines (e.g., chlortetracycline, tetracycline, oxytetracycline, doxycycline, minocycline); macrolides (e.g., erythromycin, tylosin, tlimicosin, clarithromycin, azithromycin, tulathromycin); lincosamides (e.g., lincomycin, clindamycin); aminoglycosides (e.g., gentamicin, amikacin, kanamycin, apramycin, tobramycin, neomycin, dihydrostreptomycin, paromomycin).

The antiemetic can be selected among maropitant and aprepitant.

The parasiticidal agent can be selected among organochlorines, organophosphates, carbamates, amidines, pyrethrins and synthetic pyrethroids, benzoylureas, juvenile hormone analogues, macrocyclic lactones, neonicotinoids, phenylpyrazoles, spinosyns, such as spinosad, isoxazolines, such as fluralaner, afoxolaner, sarolaner and lotilaner and meta-diamides, such as modoflaner.

The JAK-1 inhibitor can be selected among oclacitinib, momelotinib, tofacitinib and ruxolitinib.

Preferred pharmaceutical active substances are grapiprant, oclacitinib, fluralaner and modoflaner.

In the sense of the present invention, a nutraceutical ingredient refers to an ingredient whose purpose is to assist or maintain the health of the target animal. For example, the nutraceutical ingredient may provide a nutritional benefit to the target animal. Nutraceutical ingredients include notably vitamins, minerals, plant extracts and combinations thereof.

Vitamins include, for example, vitamin A, vitamin E, vitamin B12, vitamin B3, d-pantothenic acid (vitamin B5), folic acid, vitamin B6, vitamin B1, vitamin D3, vitamin C, vitamin B2 and pro-vitamins such as beta-carotene or panthenol.

Minerals include potassium, sodium, manganese, zinc, iron, calcium, copper, cobalt, iodine, chlorine, and selenium. The mineral may be in the form of a suitable salt.

Other contemplated nutraceutical ingredients include lecithines, phosphatidylserine, antioxidants such as Pycnogenol, Gingko biloba extracts, Bacopa monnieri extracts, huperzine A, omega-3 polyunsaturated fatty acids such as DHA, EPA; flavonoids or extracts of botanicals containing flavonoids such as blueberry or maqui berry, anthocyanins, flavan-3-ols, epigallocatechin-gallate (ECGC) and proanthocyanidins, isoflavones, e.g., puerarin and genistein and flavonols, e.g., rutin and troxerutin; cytochrome C, monosodium glutamate, N-acetyl cysteine, zinc methionine, biotine, L-carnitine, phytoceramides, prebiotics, probiotics, postbiotics, casein phosphopeptides, L-theanine or green tea extract, ashwaganda and fish protein hydrolysates.

In a particular embodiment, the nutraceutical ingredient is selected from the group consisting of eggshell membrane; krill powder or krill oil, astaxanthin or a source of astaxanthin such as algae, yeast, salmon, trout, krill, shrimp, and crayfish; boswellia serrata; hyaluronic acid or salts thereof; and vitamin D3. Preferably, the nutraceutical is a mixture of at least two, at least three or at least four nutraceutical ingredients selected from the group consisting in eggshell membrane; krill powder, astaxanthin or a source of astaxanthin such as algae, yeast, salmon, trout, krill powder or krill oil, shrimp, and crayfish; boswellia serrata; hyaluronic acid or salts thereof; and vitamin D3. Even more preferably, the nutraceutical is a mixture of eggshell membrane, krill powder or krill oil, astaxanthin, boswellia serrata, hyaluronic acid or salts thereof, and vitamin D3.

In a preferred embodiment, the nutraceutical ingredient is selected from the group consisting of eggshell membrane; krill powder, astaxanthin or a source of astaxanthin such as algae, yeast, salmon, trout, krill, shrimp, and crayfish; boswellia serrata; hyaluronic acid or salts thereof; and vitamin D3, preferably a mixture of 2, 3, 4 or 5 thereof. In another most preferred embodiment, the nutraceutical ingredient is a mixture of eggshell membrane; krill powder, astaxanthin or a source of astaxanthin such as algae, yeast, salmon, trout, krill, shrimp, and crayfish; boswellia serrata and hyaluronic acid or salts thereof.

The nutraceutical ingredient may be present in the soft chew in any amount, as needed to obtain the desired therapeutic effect or health benefit.

The soft chew according to the invention comprises preferably between 1 to 20 wt. % based on the total weight of the soft chew of at least one nutraceutical ingredient and/or at least one pharmaceutical active substance, more preferably between 1 to 10 wt. %.

In the soft chew according to the invention, the at least one palatant may be any ingredient known to improve the acceptability of a formulation by an animal. Palatants are well known in the art and are commercially available from companies such as Kemin Industries, Diana Pet Food (SPF) or AFB International.

When the palatant is of animal origin, it can be for example derived from animal tissues. Notable examples are pork liver and poultry liver, hydrolyzed or not. In one embodiment, the palatant is poultry liver powder.

Preferably, the palatants are of non-animal origin. Palatants of non-animal origin include chemically synthesized compounds that are used to flavour food items; yeasts, in particular Brewer's yeast; essential oils; oleoresin; essence or extract, vegetable protein hydrolysates; distillates; and any product of roasting, heating or enzymolysis, which contains the flavouring constituents derived from a spice, fruit or fruit juice, vegetable or vegetable juice, edible yeast (active and inactive), herb, bark, bud, root, leaf or any other edible portions of a plant.

Most palatants of non-animal origin are mixtures of ingredients that are kept confidential by palatant manufacturers. The main palatant manufacturers are the companies Diana Pet Food, Kemin Industries and AFB International. Palatants of non-animal origin sold by Kemin Industries belong to the PALASURANCE P-series flavour enhancer range. It uses plant-based proteins and Maillard technology to generate pet-friendly aromas and flavours that are compatible with all animal proteins. Palatants of non-animal origin sold by Diana Pet Food include palatants described as a blend of vegetable derivatives, yeasts, sugars, nutritional additives, mineral substances, sensory additives, and preservatives.

In a preferred embodiment, the palatant is a blend of vegetable derivatives, yeasts, sugars, nutritional additives, mineral substances, sensory additives, and preservatives sold by SPF Diana.

The soft chew according to the invention comprises preferably between 5 and 30 wt. % based on the total weight of the soft chew of the at least one palatant, more preferably between 10 and 20 wt. %, more preferably about 15 wt. %, or 20 wt. %.

In a particular embodiment, the soft chew according to the invention comprises between 15 and 50 wt. % of starch based on the total weight of the soft chew and between 5 and 30 wt. % based on the total weight of the soft chew of a palatant.

The soft chew according to the invention preferably further comprises one or more further ingredients selected from the group consisting of:
at least one humectant,
at least one binder,
water,
at least one protein source, preferably of non-animal origin,
at least one emulsifier, and
at least one preservative and/or antioxidant.

In the soft chews according to the invention, at least one humectant may be present.

In the sense of the present invention, a humectant refers to a substance that is hygroscopic, e.g. has the affinity to form hydrogen bonds with molecules of water, and is capable of keeping the soft chew dough moist. Humectants are well known to those skilled in the art.

Preferably, the humectant is a polyol or a mixture of polyols. Examples of polyols useful as humectants are ethylene glycol, propylene glycol, sugar polyols such as glycerol, sorbitol, xylitol and maltitol, polymeric polyols such as polydextrose, maltodextrines and molasses. More preferably, the humectant is selected from glycerol, sorbitol, maltodextrines and molasses or mixtures thereof and a mixture of glycerol and sorbitol.

The soft chew according to the invention comprises between 10 and 30 wt. % based on the total weight of the soft chew of at least one humectant, preferably between 15 and 25 wt. %, more preferably about 20, 21 or 22 wt. %.

In the soft chews according to the invention, at least one binder may be present. In the sense of the present invention, a binder or binding agent refers to a substance used to improve the binding properties of the powdered mass, to assist the formation of the soft chew.

Any suitable binder known in the art may be used. In one embodiment the binder is selected from gums such as xanthan gum or guar gum, waxes, alginates, cellulose, and their derivatives such as methylcellulose or microcrystalline cellulose, starch derivatives and polymers such as povidones, methacrylates and polyethylene oxides, or any combination of any two or more thereof. Preferably, the binder is selected from cellulose powder and gum arabic, more preferably a mixture of cellulose powder and gum arabic.

The soft chew according to the invention comprises between 0.1 and 5 wt. % based on the total weight of the soft chew of at least one binder, preferably between 2 and 3 wt. %.

In the soft chews according to the invention, water may be present.

In the present invention, the amount of water present in the soft chew may be determined using methods well known in the art such as Karl Fischer methods (e.g. KF titrators, KF oven/evaporators, moisture meters) and thermogravimetric analysis, particularly Karl Fischer methods.

The addition of water is useful for the manufacturing of the soft chews according to the invention, in particular for the processability of the dough, as detailed in another aspect of the invention.

The soft chew according to the invention may comprises between 10 and 25 wt. % of water based on the total weight of the soft chew, preferably between 15 and 20 wt. % of water.

The soft chew according to the present invention can be further characterized by water activity. Typically, the value of water activity aw of the soft chew according to the invention is below 0.80, preferably below 0.70. most preferred is a water activity aw in the range of from 0.60 to 0.70, such levels of water activity being compatible with the conservation of the soft chew at room temperature for sufficient periods of time of several months.

In the soft chews according to the invention, at least one protein source, preferably of non-animal origin, may be present.

The protein source of the invention may originate from a variety of sources known by those skilled in the art, including plant sources, animal sources and yeast sources.

Animal sources include, for example, meat, meat by-products, dairy products, and eggs. Meat includes, for example, the flesh of poultry, fish, and mammals such as cattle, pigs, sheep, and goats. Meat by-products include, for example, lungs, kidneys, brain, livers, stomachs, and intestines (free of all or essentially all of their contents).

Non-animal protein sources include plant protein sources, preferably selected from the group consisting of soy proteins including soy protein isolates, pea proteins, flax seed proteins, corn proteins, wheat proteins (gluten), oat proteins, barley proteins, alfalfa proteins, rye proteins, rice proteins and potato proteins; and fungi sources, preferably yeast proteins including inactivated brewer's yeast.

Preferably, the protein source is of non-animal origin and is selected from inactivated Brewer's yeast, soy protein, wheat protein (gluten) and pea proteins.

The soft chew according to the present invention comprises between 1 and 15 wt. % of at least one protein source, preferably of non-animal origin, based on the total weight of the soft chew, preferably between 2 and 10 wt. %.

In one preferred embodiment, the soft chew according to the invention is gluten-free.

Gluten is a group of seed storage proteins found in certain cereal grains, in particular rye, oats, wheat and barley.

A gluten free formulation for the soft chew is particularly beneficial for animals that have gluten intolerance.

In the soft chews according to the invention, at least one emulsifier may be present. In the present invention, emulsifiers (or emulsifying agents or emulgents) refer to substances that act as stabilizers between the hydrophobic ingredients (oils for example) and the hydrophilic excipients (starch and humectants for example).

Any suitable emulsifier may be used in the soft chew according to the present invention. Preferred emulsifiers are lecithins, including soy lecithin and sunflower lecithin.

The soft chew according to the present invention comprises between 1 and 5 wt. % of at least one emulsifier based on the total weight of the soft chew, preferably between 1 and 2 wt. %, more preferably 1,5 or 2 wt. %.

In the soft chews according to the invention, at least one preservative and/or antioxidant may be present.

In the present invention, preservatives are substances that prevent microbiological contamination and improve the stability of the formulation, including the nutraceutical and/or pharmaceutical ingredient.

Preservatives are well known in the art and can be selected depending on the active ingredient and/or formulation.

The preservative is preferably selected from acids, alcohols, phenols, parabens, sorbates, thiols, phenyl mercury salts, or any combination of any two or more thereof. In a preferred embodiment the preservative is a mold inhibitor such as propionic acid blended with sorbic and benzoic acids or water-soluble combination of buffered vinegar and citric acid.

In the present invention, antioxidants are substances used to protect the active ingredient from oxidation. Some preservatives may also act as antioxidants.

Any antioxidant known in the art may be used. Preferably, the antioxidant is selected from propyl gallate, ascorbic acid and its derivatives, sodium formaldehyde sulfoxylate, malic acid, fumaric acid, editic acid, thiols, polyphenols, sodium EDTA, sodium ascorbate, sodium metabisulfite, butylated hydroxytoluene, butylated hydroxyanisole, or natural substances such as flavanoids, tocopherols, carotenes, cysteine, or any combination of any two or more thereof.

The soft chew according to the present invention comprises between 0.25 and 2 wt. % of at least one preservative and/or antioxidant, preferably between 1 and 2 wt. %.

Other optional ingredients may also be present including in particular lubricants such as magnesium stearate, fumaric acid, sodium stearyl fumarate or disintegrants such as sodium starch glycolate, crospovidone (Polyplasdone XL™) and croscarmellose sodium (Ac-Di-SoI™).

In a particular embodiment, the soft chew according to the invention is substantially free of ingredients of animal origin and therefore contains less than 10 wt. % of substances of animal origin based on the total weight of the soft chew, advantageously less than 6.0 wt. % and preferably less than 5.5 wt. % of substances of animal origin.

Preferably, the soft chew according to the invention comprises as further ingredients at least one palatant, preferably of non-animal origin, at least one humectant and water.

The invention therefore also encompasses a soft chew formulation comprising:
at least one nutraceutical ingredient and/or at least one pharmaceutical active substance;
no more than 6 wt. % oil, fat or a mixture thereof based on the total weight of the soft chew;
starch;
at least one palatant of non-animal origin,
at least one humectant, and
water,
wherein at least 50 wt. % by weight of total starch weight present in the soft chew is provided by pregelatinized rice flour.

The invention further encompasses a soft chew formulation comprising:
at least one nutraceutical ingredient and/or at least one pharmaceutical active substance;
no more than 6 wt. % oil, fat or a mixture thereof based on the total weight of the soft chew;
starch;
at least one palatant of non-animal origin,
at least one humectant,
at least one binder,
water,
at least one protein source of non-animal origin,
at least one emulsifier, and
at least one preservative and/or antioxidant.
wherein at least 50 wt. % by weight of total starch weight present in the soft chew is provided by pregelatinized rice flour.

In a preferred embodiment, the invention also encompasses a soft chew formulation substantially free of excipients of animal origin, comprising:
at least one nutraceutical ingredient and/or at least one pharmaceutical active substance;
no more than 6 wt. % oil, fat or a mixture thereof based on the total weight of the soft chew;
starch;
at least one palatant of non-animal origin,
at least one humectant,
water,
and optionally,
at least one binder,
at least one protein source of non-animal origin,
at least one emulsifier, and
at least one preservative and/or antioxidant.
wherein at least 50 wt. % by weight of total starch weight present in the soft chew is provided by pregelatinized rice flour.

The present invention also relates to soft chews as described above, containing:
at least one nutraceutical ingredient and/or at least one pharmaceutical active substance,
15 to 25 wt. % based on the total weight of the soft chew of starch, wherein at least 50 wt. % by weight of total starch weight, preferably 60 wt. % of said starch, even more preferably at least 70 wt. % is provided by pregelatinized rice flour,
at least one protein source of non-animal origin,
at least one vegetable oil,
at least one emulsifier,
at least one palatant of non-animal origin,
at least one humectant, and
water.

In a specific embodiment, the soft chew contains:
1 to 10 wt. % based on the total weight of the soft chew of at least one nutraceutical ingredient and/or at least one pharmaceutical active substance,
15 to 25 wt. % based on the total weight of the soft chew of starch, wherein at least 50 wt. % by weight of total starch weight, preferably 60 wt. %, even more preferably at least 70 wt. % of said starch is provided by pregelatinized rice flour,
at least one protein source of non-animal origin,
3 to 6 wt. % based on the total weight of the soft chew of at least one vegetable oil,
at least one emulsifier,
at least one palatant of non-animal origin,
at least one humectant, and
water.

In another specific embodiment, the soft chew comprises, based on the total weight of the soft chew:
1 to 10 wt. % of at least one nutraceutical ingredient and/or at least one pharmaceutical active substance,
15 to 25 wt. % of starch, wherein at least 50 wt. % by weight of total starch weight, preferably 60 wt. % of said starch is provided by pregelatinized rice flour,
2 to 10 wt. %. of a protein source of non-animal origin,
3 to 6 wt. % of at least one vegetable oil,
10 to 20 wt. % of at least one palatant of non-animal origin,
10 to 25 wt. % of at least one non-aqueous humectant, and
15 to 20 wt. % of water.

In a more preferable embodiment, the soft chew contains:
1 to 10 wt. % based on the total weight of the soft chew of at least one nutraceutical ingredient and/or at least one pharmaceutical active substance,
15 to 25 wt. % based on the total weight of the soft chew of starch, wherein at least 50 wt. % by weight of total starch weight, preferably 60 wt. %, even more preferably at least 70 wt. % of said starch is provided by pregelatinized rice flour,
1 to 11 wt. % based on the total weight of the soft chew of at least one protein source of non-animal origin,
3 to 6 wt. % based on the total weight of the soft chew of at least one vegetable oil,
1 to 3 wt. % based on the total weight of the soft chew of at least one emulsifier,
10 to 20 wt. % based on the total weight of the soft chew of at least one palatant of non-animal origin,
10 to 25 wt. % based on the total weight of the soft chew of at least one humectant, and
15 to 20 wt. % of water based on the total weight of the soft chew.

In another aspect, the invention relates to a process to manufacture a soft chew as defined in the specification comprising the following steps:
i. mixing the following components:
   at least one nutraceutical ingredient and/or at least one pharmaceutical active substance,
   at least one source of starch,
   pregelatinized rice flour in an amount sufficient to provide at least 50 wt. % by weight of total starch weight,
   no more than 6 wt. % of oil, fat or a mixture thereof based on the total weight of the components,
   and optionally one or more further ingredients selected from the group consisting of:
   at least one palatant, preferably of non-animal origin,
   at least one humectant,
   at least one binder,
   water,
   at least one protein source, preferably of non-animal origin,
   at least one emulsifier, and
   at least one preservative and/or antioxidant,
   ii. forming a soft chew.

Preferably, step i. of mixing is performed at room temperature, i.e. without using an external source of heat. Carrying out the process at room temperature makes it possible to use heat sensitive nutraceutical ingredients and/or pharmaceutical active substances without degradation. As a non-limitative example, the process makes it possible to obtain soft chews containing probiotics without killing the probiotic bacteria during the process.

Step i. and step ii. may occur simultaneously or separately, depending on the machines used.

In one embodiment, mixing is performed prior to forming the soft chews.

In a first alternative, mixing is performed in a mixer until a homogeneous dough is obtained. It has been found that mixers conventionally employed to manufacture soft chews (e.g. the ones conventionally used in the pharmaceutical and food industries) did not make it possible to obtain a homogeneous dough because the mixture was too viscous if not heated during the mixing (to prevent a possible degradation of the actives). Therefore, mixers equipped with a Z-arm, a T-arm, or a S-arm, preferably a Z-arm, more conventionally used in the plastics industry, were preferred.

In a second alternative, mixing is performed in an extruder. All the ingredients of the soft chew may be charged in an inlet port, mixed in the extruder during conveyance to the discharge port or the solid ingredients charged in the inlet port and the liquids added through additional inlet ports located on the barrel of the extruder to provide a dough.

The dough obtained in the mixer, or the extruder is then formed into a soft chew of appropriate size and weight.

The soft chew may be formed by any method known in the art. A variety of forming equipment may be utilized in the invention, for example, the molding machines disclosed in U.S. Pat. Nos. 3,486,186; 3,887,964; 3,952,478; 4,054,967; 4,097,961; 4,182,003; 4,334,339; 4,338,702; 4,343,068; 4,356,595; 4,372,008; 4,535,505; 4,597,135; 4,608,731; 4,622,717; 4,697,308; 4,768,941; 4,780,931; 4,818,446; 4,821,376; 4,872,241; 4,975,039; 4,996,743; 5,021,025; 5,022,888; 5,655,436; and 5,980,228, and in US patent application US 2014/0141055 or tablet presses. Particularly contemplated are the Formax F6 molding machine and the rotary molding machines, including described in US 2014/0141055 (MFT-200 of KrOger & Salecker, Bad Schwartau).

In another embodiment, mixing and forming are performed with the extruder. All the ingredients of the soft chew may be charged in an inlet port, mixed in the extruder during conveyance to the discharge port or the solid ingredients charged in the inlet port and the liquids added through additional inlet ports located on the barrel of the extruder. The soft chew is shaped (formed) by the die of the extruder and the extrudate cut into soft chews of appropriate size and weight.

For the purpose of the invention, the term extruder refers to mono-, twin- and multi-screw extruders, planetary roller extruders, vacuum filler extruders and cascade extruders, extruders equipped with a pusher, without being limited to these extruder variants. Preferably, the extruder is an extruder equipped with a pusher.

Preferably, in the processes for manufacturing the soft chews described above, in step i. of mixing, the solids are first mixed together then the liquids are added. More preferably, the at least one oil and water are added sequentially to the solids. In one particular embodiment, the at least one oil is added first to the solids then water is added. It has been observed that addition of the at least one oil before the addition of water to the solid ingredients results in a lesser exudation of oil from the soft chew.

The process may additionally comprise an additional drying step after step ii, which is a third step iii. of drying, said drying step being preferably performed at room temperature for at least 15 minutes.

In the sense of the present invention, a drying step refers to a step of maturation aiming at favoring the phenomena of starch cross-linking and network reorganization to get into a more stable state and to avoid the chews to stick with each other.

The drying step is preferably performed by leaving the soft chew on a planar surface for a sufficient time after formation of the soft chews, to let it dry. It has been found that neither heating nor cooling accelerates the maturation of the soft chews. The drying step may therefore be performed at room temperature (e.g. between 15 and 30° C., in the cold (e.g. between −15 and 15° C.) or at hot temperature (e.g. between 3° and 60° C.). The drying time may be readily determined by the person skilled in the art. Preferably, the soft chew is dried for a period between 15 minutes and 24 hours, more preferably between 1 hour and 12 hours, in particular about 1 hour.

The present invention therefore concerns in a more specific embodiment a process to manufacture a soft chew as defined previously comprising the following steps:
i. mixing the following components:
at least one nutraceutical ingredient and/or at least one pharmaceutical active substance,
at least one source of starch,
pregelatinized rice flour in an amount sufficient to provide at least 50 wt. % by weight of total starch weight,
no more than 6 wt. % of at least one oil, fat, or a mixture thereof and
optionally, one or more further ingredients selected from the group consisting of:
at least one palatant, preferably of non-animal origin,
at least one humectant,
at least one binder,
water,
at least one protein source, preferably of non-animal origin,
at least one emulsifier, and
at least one preservative and/or antioxidant,
ii. forming a soft chew, and
iii. drying the soft chew.

After drying, the soft chews can be packed into bottles or containers. Said containers can be glass containers, glass bottles, plastic (for example HDPE) bottles or plastic (for example HDPE) containers.

The present invention therefore also concerns a process as described above, comprising a step iv. of packaging the soft chews.

In another aspect, the present invention concerns a soft chew as previously described, comprising notably at least one nutraceutical ingredient and/or at least one pharmaceutical active substance, no more than 6 wt. % oil, fat or a mixture thereof based on the total weight of the components said soft chew comprising at least one source of starch and wherein at least 50 wt. % by weight of total starch present in the soft chew is provided by pregelatinized rice flour, for use as a medicament in a non-human animal. Preferably, the soft chew according to the invention is for use as a medicament in dogs or cats.

The present invention also concerns the use of a soft chew as previously described, comprising at least one nutraceutical ingredient and/or at least one pharmaceutical active substance, no more than 6 wt. % oil, fat or a mixture thereof based on the total weight of the components, at least one source of starch and wherein at least 50 wt. % by weight of total starch present in the soft chew is provided by pregelatinized rice flour, for treating a disease in a non-human animal.

The present invention also concerns a method for treating a non-human animal in need thereof for a disease, comprising administering to said non-human animal a soft chew as previously described comprising at least one nutraceutical ingredient and/or at least one pharmaceutical active substance, no more than 6 wt. % oil, fat or a mixture thereof based on the total weight of the components, at least one source of starch and wherein at least 50 wt. % by weight of total starch present in the soft chew is provided by pregelatinized rice flour.

The present invention also concerns the use of a soft chew as previously described comprising at least one nutraceutical ingredient and/or at least one pharmaceutical active substance, no more than 6 wt. % oil, fat or a mixture thereof based on the total weight of the components, at least one source of starch and wherein at least 50 wt. % by weight of total starch present in the soft chew is provided by pregelatinized rice flour according to the invention for the manufacture of a medicament for a non-human animal.

The term “treatment”, and related terms, such as “treating” and “treat” as used herein, relates generally to treatment, of a non-human animal, in which some desired therapeutic effect is achieved. The therapeutic effect may, for example, be the inhibition of progress of a disease or condition, including a reduction in the rate of progress, a halt in the rate of progress, amelioration, and cure. Treatment as a prophylactic measure is also included. Treatment also includes combination treatments and therapies, in which two or more treatments or therapies are used, for example, sequentially or simultaneously, in combination.

In a preferred embodiment of the invention:
the nutraceutical is selected from the group consisting of eggshell membrane; krill powder, astaxanthin or a source of astaxanthin such as algae, yeast, salmon, trout, krill, shrimp, and crayfish; boswellia serrata; hyaluronic acid or salts thereof; and vitamin D3. Preferably, the nutraceutical is a mixture of at least two, at least three or at least four nutraceutical ingredients selected from the group consisting in eggshell membrane; krill powder, astaxanthin or a source of astaxanthin such as algae, yeast, salmon, trout, krill, shrimp, and crayfish; boswellia serrata; hyaluronic acid or salts thereof; and vitamin D3. Even more preferably, the nutraceutical is a mixture of eggshell membrane, krill powder, astaxanthin, boswellia serrata, hyaluronic acid or salts thereof, and vitamin D3, and
the treatment is prevention or treatment, and the disease is a joint disorder, in particular arthritis or osteoarthritis, preferably, the treatment of arthritis in dogs and/or for supporting healthy bones, supporting joint flexibility and/or mobility or supporting the viscosity of the synovial fluid.

In another preferred embodiment of the invention:
the at least one pharmaceutical active substance is an isoxazoline selected from afoxolaner, sarolaner, lotinaler and afoxolaner, preferably fluralaner, and
the treatment is the prevention and/or treatment of an ectoparasite infestation, preferably a flea or tick infestation.

In a further referred embodiment of the invention:
the at least one pharmaceutical active substance is a JAK-1 inhibitor selected from oclacitinib, momelotinib, tofacitinib, N-methyl-6-[methyl(7H-pyrrolo[2,3-d]pyrimidin-4-yl)amino]spiro[3.3]heptane-2-sulfonamide and ruxolitinib, preferably oclacitinib or N-methyl-6-[methyl(7H-pyrrolo[2,3-d]pyrimidin-4-yl)amino]spiro[3.3]heptane-2-sulfonamide,
the treatment is the treatment of pruritus associated with allergic dermatitis and/or the treatment of clinical manifestations of atopic dermatitis, in particular in dogs.

In yet another preferred embodiment of the invention:
the at least one pharmaceutical active substance is grapiprant, and
the treatment is the treatment of osteoarthritis pain and inflammation, in particular in dogs.

In yet a further preferred embodiment of the invention:
the at least one pharmaceutical active substance is modoflaner, and
the treatment is the prevention and/or treatment of an ectoparasite infestation, preferably a flea or tick infestation, in particular in dogs and cats.

In another aspect, the present invention concerns the use of a soft chew as previously described, comprising at least one nutraceutical ingredient, for providing to a non-human animal a health benefit.

In a preferred embodiment of the invention:
the nutraceutical is selected from the group consisting of eggshell membrane; krill powder, astaxanthin or a source of astaxanthin such as algae, yeast, salmon, trout, krill, shrimp, and crayfish; boswellia serrata; hyaluronic acid or salts thereof; and vitamin D3. Preferably, the nutraceutical is a mixture of at least two, at least three or at least four nutraceutical ingredients selected from the group consisting in eggshell membrane; krill powder, astaxanthin or a source of astaxanthin such as algae, yeast, salmon, trout, krill, shrimp, and crayfish; boswellia serrata; hyaluronic acid or salts thereof; and vitamin D3. Even more preferably, the nutraceutical is a mixture of eggshell membrane, krill powder, astaxanthin, boswellia serrata, hyaluronic acid or salts thereof, and optionally vitamin D3, and
the health benefit is selected from supporting healthy bones, supporting joint flexibility and/or mobility and supporting the viscosity of the synovial fluid.

The present invention also concerns a method for providing to a non-human animal a health benefit, comprising administering to said non-human animal a soft chew comprising at least one nutraceutical ingredient according to the invention.

According to the invention, the non-human animal is preferably a companion animal, in particular selected from the group consisting of dogs, cats, ferrets. More preferably, the companion animal is a dog.

### EXAMPLES

### Example 1: General Procedure for the Manufacture of the Soft Chews

Four different soft chews A to D were prepared according to the following general method:

All the solid ingredients were weighted and placed in a mixer as a sandwich: addition of half of the excipients in the mixer, followed by the addition of the blend of active ingredients and finally addition of the other half of the excipients. The solid blend was mixed.

Oil was added to the solid blend and the blend mixed.

A liquid blend containing water, cellulose, humectants (glycerol/sorbitol/molasses/maltodextrines) was distributed on the solid/oil blend and the whole was mixed again until visually homogeneous.

The inlet of an extruder was charged with the dough and the blend was extruded. The extrudate was cut into individual soft chews of two grams, four grams or six grams.

The individual soft chews were then placed on a tray at ambient temperature about one hour to let them mature, then conditioned into boxes (about thirty soft chews per box) that were closed and hermetically sealed.

### Example 2: Compositions of the Soft Chews

Four compositions containing respectively 37% (Composition A), 49% (Composition B) and 71% (Composition C and D) of starch originating from rice flour based on the total weight of starch were evaluated. The compositions are detailed in Table 1.

TABLE 1
(all amounts of ingredients are given in wt.
% of the total weight of the soft chew).

| Ingredient / Composition | A | B | C | D |
|---|---|---|---|---|
| Pregelatinized Indica rice | 8.208 | 11.100 | 17.965 | 21.075 |
| flour | | | | |
| Pregelatinized potato starch | 8.000 | 7.463 | 3.960 | |
| Pregelatinized cassava | 3.514 | 2.000 | | |
| starch | | | | |
| Pregelatinized corn starch | | | 1.980 | 5.000 |
| Pregelatinized rice starch | | | | 2.000 |
| (Japonica) | | | | |
| Soy protein isolate | 3.000 | 2.000 | 3.960 | |
| Wheat gluten | | 6.000 | | |
| Pea proteins | 5.171 | 2.865 | 6.120 | 2.745 |
| Glycerin | 18.000 | 18.000 | 17.822 | 14.500 |
| Sorbitol | | | | 4.500 |
| Molasses | 2.000 | 2.000 | 1.980 | 2.000 |
| Maltodextrin | | | | 1.000 |
| Sunflower oil | 5.000 | 5.000 | 4.951 | 5.000 |
| Soy lecithin | 1.500 | 2.000 | 1.485 | 2.000 |
| Cellulose powder | 0.300 | 0.300 | 0.297 | 0.300 |
| Gum arabic | 2.500 | 2.000 | 2.475 | 2.000 |
| Non-animal origin palatant* | 20.000 | 15.000 | 14.852 | 15.000 |
| Astaxanthin source | 0.833 | 0.833 | 0.825 | 0.833 |
| Egg shell membrane | 3.300 | 3.300 | 3.267 | 3.300 |
| Hyaluronic acid | 0.490 | 0.490 | 0.485 | 0.490 |
| Boswellia serrata | 1.625 | 1.625 | 1.609 | 1.625 |
| Vitamin D3 | 0.005 | 0.005 | 0.005 | 0.005 |
| Krill powder | 1.850 | 1.850 | 1.832 | 1.850 |
| Preservatives | 2.000 | 1.500 | 1.188 | 1.200 |
| Antioxidant | 0.250 | 0.250 | 0.248 | 0.250 |
| Water | 12.454 | 14.419 | 12.694 | 13.327 |
| Rice starch from rice flour / | 37% | 49% | 71% | 71% |
| total starch | | | | |

*blend of vegetable derivatives, yeasts, sugars, nutritional additives, mineral substances, sensory additives, and preservatives

### Example 3: Characterization of the Soft Chews

### Example 3.1: Moisture and Water Activity

The determination of the moisture content and water activity of the soft chews were performed employing standard methods (Karl Fischer and capacitance sensor, respectively).

The results are provided in Table 2:

TABLE 2

| Composition | A | B | C | D |
|---|---|---|---|---|
| Moisture (Karl | 16.36 ± | 14.53 ± | 15.00 ± | 15.44 ± |
| Fisher | 3.27 | 2.91 | 3.00 | 3.09 |
| (%)) | | | | |
| Aw | 0.676 ± | 0.650 ± | 0.657 ± | 0.685 ± |
| | 0.012 | 0.012 | 0.012 | 0.012 |

Moisture content of the soft chews ranged between 14 and 17%. The Aw was below 0.7 which is compatible with long term storage at ambient temperature.

### Example 3.2: Sensory Evaluation of the Soft Chews

This evaluation was a subjective evaluation. The shape, stickiness, texture, and friability were evaluated. The results are reported in Table 3:

| Compositions | A | B | C | D |
|---|---|---|---|---|
| Shape | Well-shaped, | Well- | Well-shaped, | Well- |
| | slight | shaped | slight | shaped |
| | deformation | | deformation | |
| Stickiness | Few | Yes | No | few / a little |
| Texture | firm, elastic | firm, elastic | Very firm, | Very firm, |
| | | | elastic | elastic |
| Friability | can be split | can be split | can be split | can be split |
| | into two | into two | into two | into two |
| | pieces | pieces | pieces | pieces |

In this sensory evaluation, the soft chews can be classified in the following order (worst to better): Composition B<Composition A<Composition D=Composition C

From a sensory evaluation, a weight percentage of starch provided from rice flour of about 70 (based on the total amount of starch) improves the sensory properties of the soft chew. With less than 50% of the total starch provided from rice flour (37% or 49%), the soft chews are, from a sensory evaluation, less acceptable.

### Example 3.3: Stickiness of the Soft Chews Over Time

An evaluation of the stickiness of the soft chews immediately after manufacture (TO) and after 15 days was performed.

“Yes” indicates that the soft chews stick together when removed from the package by hand.

“Slightly” indicates that some soft chews stick together when removed from the package by hand.

“No” indicates that the soft chews can be removed one by one from the package by hand.

The results are reported in Table 4.

TABLE 4

| Compositions | A | B | C | D |
|---|---|---|---|---|
| Stick together at T0? | Yes | Yes | Slightly | Slightly |
| Stick together after 15 days? | Yes | Yes | No | No |

Based on the above results, the soft chews can be classified from the stickiest to the less sticky: Composition C>Composition D>Composition A>Composition B.

From this study, it can be concluded that a weight percentage of starch provided from rice flour of about 70 (based on the total amount of starch) significantly reduces the stickiness of the soft chew even after 15 days storage. With less than 50% of the total starch provided from rice flour (37% or 49%), the soft chews are sticky.

### Example 3.4. Texture Analysis

The firmness of the soft chews was determined on a TA XT Plus texturometer (Stable Micro Systems) using a P/0,5S spherical probe of 0.5 inches (1.27 cm) with the following parameters implemented directly in the software of the texturometer:

| Caption | Value | Units |
|---|---|---|
| Test Mode | Compression | |
| Pre-Test Speed | 1.00 | mm/sec |
| Test Speed | 2.00 | mm/sec |
| Post Test Speed | 5.00 | mm/sec |
| Target Mode | Distance | |
| Distance | 3.00 | mm |
| Trigger Type | Auto (Force) | |
| Trigger Force | 5.0 | g |
| Break Mode | Off | |
| Stop Plot at | Start Position | |
| Tare Mode | Auto | |

Briefly, the sample (soft chew) was placed on a flat base/surface and the spherical probe was lowered into the sample to a distance of 3 mm at a predetermined speed. The sample was deformed by the probe and the resistance offered by the sample (force required to penetrate of 3 mm) was recorded. The measured resistance expressed in kgf (1 kgf=9,80665 N) corresponds to the firmness of the soft chews.

The results are reported in Table 5 for soft chews of 2 g and 6 g.

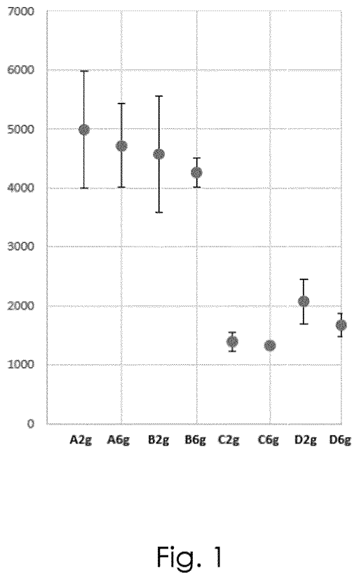

A graphical representation is also provided in FIG. 1.

TABLE 5
Texture refers to the firmness in kgf.

| Compositions | A | B | C | D |
|---|---|---|---|---|
| Texture of the 2 g soft | 2.074 ± | 1.396 ± | 4.572 ± | 4.985 ± |
| chew | 0.386 | 0.158 | 0.979 | 0.991 |
| Texture of the 6 g soft | 1.674 ± | 1.328 ± | 4.260 ± | 4.713 ± |
| chew | 0.188 | 0.25 | 0.245 | 0.709 |

From the results of the texture analysis, it can be concluded that increasing the amount of pregelatinized rice flour in the soft chew results in a significant increase of the firmness.

The presence of a weight percentage of starch provided from rice flour of about 70 (based on the total amount of starch) has a profound beneficial effect on the texture of the soft chews. Conversely, with less than 50% of the total starch provided from rice flour (37% or 49%), the soft chews are too soft.

### Example 3.5. Oil Exudation

An evaluation of the oil leakage was performed.

Briefly, two soft chews A and C were placed on a piece of paper for about 12 hours. After this time, the soft chews were removed and the longer size of the oil flake on the paper was measured to assess the exudation of oil (lipids) from the soft chews.

The results are provided in Table 6.

TABLE 6

| Composition | A | C |
|---|---|---|
| Stain (cm) | 1.5 | <0.5 |

The presence of a weight percentage of starch provided from rice flour of about 70 (based on the total amount of starch) has a profound beneficial effect on the exudation of oil from the soft chews. Conversely, with less than 50% of the total starch provided from rice flour (37%), the amount of oil exuding from the soft chew is more important.

1. A soft chew comprising:
at least one nutraceutical ingredient and/or at least one pharmaceutical active substance;
no more than 6 wt. % of oil, fat or a mixture thereof based on the total weight of the soft chew;
at least one palatant, and
starch;
wherein at least 50 wt. % by weight of total starch weight present in the soft chew is provided by pregelatinized rice flour, wherein the soft chew contains substantially no palatant of animal origin, and wherein the soft chew has a firmness comprised between 25 and 100 N.

2. Soft chew according to claim 1, having a firmness comprised between 39 and 79 N.

3. Soft chew according to claim 1, comprising one or more further ingredients selected from the group consisting of:
at least one humectant,
at least one binder,
water,
at least one protein source,
at least one emulsifier, and
at least one preservative and/or antioxidant.

4. Soft chew according to claim 1, comprising between 3 and 6 wt. % of oil, fat, or a mixture thereof.

5. Soft chew according to claim 4, comprising between 3 and 6 wt. % of oil.

6. Soft chew according to claim 1, wherein at least 60 wt. % of total starch weight present in the soft chew is provided by pregelatinized rice flour.

7. Soft chew according to claim 1, comprising between 15 and 50 wt. % of starch based on the total weight of the soft chew and between 5 and 30 wt. % of a palatant based on the total weight of the soft chew.

8. Soft chew according to claim 1, comprising between 1 and 20 wt. % based on the total weight of the soft chew of at least one nutraceutical ingredient and/or at least one pharmaceutical active substance.

9. Soft chew according to claim 3, comprising, based on the total weight of the soft chew:
1 to 10 wt. % of at least one nutraceutical ingredient and/or at least one pharmaceutical active substance,
15 to 25 wt. % of starch, wherein at least 50 wt. % by weight of total starch weight, is provided by pregelatinized rice flour,
2 to 10 wt. %. of a protein source of non-animal origin,
3 to 6 wt. % of at least one vegetable oil,
10 to 20 wt. % of at least one palatant of non-animal origin,
10 to 25 wt. % of at least one non-aqueous humectant, and
15 to 20 wt. % of water.

10. Soft chew according to claim 1, wherein the nutraceutical ingredient is selected from the group consisting of eggshell membrane; krill powder, astaxanthin or a source of astaxanthin such as algae, yeast, salmon, trout, krill, shrimp, and crayfish; boswellia serrata; hyaluronic acid or salts thereof; vitamin D3, and combinations thereof.

11. Soft chew according to claim 1, wherein the soft chew has a break force of less than 100 N.

12. A process for the manufacture of a soft chew the process comprising:
i. mixing the following ingredients:
at least one nutraceutical ingredient and/or at least one pharmaceutical active substance,
at least one source of starch,
pregelatinized rice flour in an amount sufficient to provide at least 50 wt. % by weight of total starch weight,
no more than 6 wt. % of oil, fat or a mixture thereof based on the total weight of the components,
and optionally one or more further ingredients selected from the group consisting of:
at least one palatant, preferably of non-animal origin,
at least one humectant,
at least one binder,
water,
at least one protein source, preferably of non-animal origin,
at least one emulsifier, and
at least one preservative and/or antioxidant; and
ii. forming a soft chew.

13. The process according to claim 12, comprising a drying step after forming the soft chew, said drying performed at room temperature for at least 15 minutes.

14. The process according to claim 12, wherein mixing comprises:
mixing the solids together to form a solid mixture,
adding the liquids to the solid mixture, and
adding the water after adding the oil.

15. (canceled)

16. (canceled)

17. Soft chew according to claim 1, having a firmness comprised between 40 and 60 N.

18. Soft chew according to claim 1, wherein at least 70 wt. % of total starch weight present in the soft chew is provided by pregelatinized rice flour.

19. Soft chew according to claim 1, wherein the soft chew is a medicament for non-human animals.

20. Soft chew according to claim 19, comprising a nutraceutical selected from the group consisting of eggshell membrane; krill powder, astaxanthin or a source of astaxanthin such as algae, yeast, salmon, trout, krill, shrimp and or crayfish; boswellia serrata; hyaluronic acid or salts thereof; and vitamin D3 and combinations thereof, wherein the soft chew treats arthritis in dogs and/or supports healthy bones, joint flexibility and/or mobility, or viscosity of the synovial fluid.

21. Soft chew according to claim 19, wherein the soft chew is a medicament for dogs or cats.

22. Soft chew according to claim 1, wherein the soft chew has a break force between 20 and 90 N.
